(19) United States
(12) Patent Application Publication
(10) Pub. No.: US 2007/0106739 A1
(43) Pub. Date: May 10, 2007

(54) Wireless messaging using notification messages in a wireless communication network

(76) Inventors: David Clark, Kitchener (CA); David Yach, Waterloo (CA)

Correspondence Address: JOHN J. OSKOREP, ESQ.;ONE MAGNIFICENT MILE CENTER, 980 N. MICHIGAN AVE., SUITE 1400, CHICAGO, IL, 60611, US

(21) Appl. No.: 11/303,429

(22) Filed: Dec. 16, 2005

Related U.S. Application Data
(60) Provisional application No. 60/734,391, filed on Nov. 8, 2005.
(60) Provisional application No. 60/734,389, filed on Nov. 8, 2005.

(51) Int. Cl. G06F 15/16

(52) U.S. Cl. 709/206

(57) ABSTRACT

A wireless communication system, comprising a host service, a wireless router system coupled to the host service, a wireless network coupling the wireless router system and a wireless mobile communication device (“mobile device”), adaptively delivers data to the mobile device in the wireless communication system using a pull message delivery mechanism. In one embodiment, before the actual message is sent to the mobile device, a small notification message is sent first to enable the mobile device to send a pull request to the host to fetch the incoming message. In a preferred embodiment, if a data message is received at the host service outside of an active session, a corresponding notification message is sent while no session is active to provide notification that a data message has been received at host service and is ready for retrieval. Upon activation of a session, a pull request is sent from the device to the host service to fetch the incoming data message. The data message may be an e-mail message.

### CROSS-REFERENCE TO RELATED APPLICATION(S)

This patent application claims priority to and is related to the subject matter disclosed in the following commonly-owned provisional applications: “Psuedo Message Notification in a Wireless Communication Network” filed 8 Nov. 2005, Application No. 60/734,391 (RIM No. 30557-ID) in the names of: David Clark and David Yach, and provisional application “System And Method Of Pseudo Message Notification In A Wireless Communication Network From A Plurality Of E-mail Accounts” also filed on 8 Nov. 2005, Application No. 60/734389 (RIM No. 30571-ID) in the names of: Anh Van, David Clarke, and Truyen Huynh; all of which are incorporated by reference herein.

### FIELD OF THE INVENTION

The present invention generally relates to a wireless communication system, and more specifically to a system and a method for wireless messaging using notification messages.

### BACKGROUND OF THE INVENTION

In a wireless communication system designed to deliver data to a wireless mobile communication device (“mobile device”) such as a cellular telephone, a two-way pager, a wireless communication capable personal digital assistant (“PDA”), and other similar device, there are several main components in the wireless communication system. A host service, which provides services such as e-mail, calendar, and Internet web browsing, holds the data to be delivered to the mobile device. The host service is coupled to a router, which couples the host service and a wireless network that is designed to communicate with the mobile device. To make a timely delivery of the data, the host service forwards the data for the mobile device to the router when the data becomes available. The router then forwards the data to the wireless network, which transmits the data to the mobile device. If the mobile device fails to receive the data, the router queues the data and re-forwards the data to the wireless network, which re-transmits the data to the mobile device. This process continues until the mobile device receives the data and acknowledges the reception or the process times out after a predetermined time period.

Large data messages, such as e-mails with attachment files, may exceed the file size limit of the message and/or the account. Forwarding these large messages across the wireless communication system may be taxing on the wireless infrastructure. Furthermore, wireless networks may charge the user for the bandwidth they consume or the amount of data they send across their network. This may be an expensive proposition. Just as file size limits are placed on corporate e-mail messages, a mechanism to reduce the message size is desired for receiving messages on mobile devices.

Furthermore, similar to rush hour traffic, wireless networks may experience large loads at peak time intervals. For example, numerous messages may be sent at 9 am and 5 pm, which may overload the network at these instances. However, not all messages are required to be delivered by the host service right away; as mobile device users may not be at their device or may be pre-occupied with other activities. A method of managing message delivery based on usage intervals is also desired.

### BRIEF DESCRIPTION OF THE DRAWINGS

For a better understanding of the embodiments described herein and to show more clearly how it may be carried into effect, reference will now be made, by way of example only, to the accompanying drawings which show at least one exemplary embodiment in which:

FIG. 1 is an exemplary environment in which a wireless communication system in accordance with one preferred embodiment may be practiced;

FIG. 2 is another exemplary environment in which a wireless communication system in accordance with another preferred embodiment may be practiced;

FIG. 3 is an exemplary block diagram of a preferred embodiment of a mobile communication device;

FIG. 4 is an exemplary sequence diagram to illustrate communication between a host service, wireless router and mobile device;

FIG. 5A is an exemplary sequence diagram to illustrate the display of notification messages;

FIG. 5B is an exemplary diagram illustrating the display of notification messages converted into to e-mail messages;

FIG. 6 is an exemplary flow diagram illustrating message delivery from a host service; and

FIG. 7 is an exemplary flow diagram illustrating message receipt at a mobile device.

### DETAIL DESCRIPTION OF THE PREFERRED EMBODIMENTS

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein, but rather as merely describing the implementation of the various embodiments described herein.

One embodiment discloses a method of wireless messaging between a host service and a wireless mobile device comprising the steps of providing at least one data message at the host service, creating a notification message at the host service, the notification message being indicative of the at least one data message provided, delivering during an inactive service session the notification message to the mobile device, receiving a pull request message in response to the notification message sent, and, in response to the pull request message received, delivering during an active service session the at least one data message provided to said mobile device.

Another embodiment discloses A method of wireless messaging comprising the steps of receiving at a mobile device a notification message during an inactive service session, the notification message being indicative of a data message, and, in response to the notification message received, requesting transmission of the data message during an active service session by sending from the mobile device a pull request.

In yet another embodiment, a wireless mobile device for wireless messaging is disclosed, the mobile device comprising a message application adapted to receive a notification message during an inactive service session, the notification message being indicative of a data message, the message application being further adapted to request transmission of the data message during an active service session in response to the notification message received by sending a pull request.

Examples of applicable communication devices include pagers, cellular phones, cellular smart-phones, wireless organizers, personal digital assistants, computers, laptops, handheld wireless communication devices, wirelessly enabled notebook computers and the like, each of which is capable of sending messages to one or more recipients.

A wireless communication system, comprising a host service, a wireless router system coupled to the host service, a wireless network coupling the wireless router system and a wireless mobile communication device (“mobile device”), adaptively delivers data to the mobile device in the wireless communication system using a pull message delivery mechanism. In the wireless communication system, data messages are transmitted only during active service sessions. An active session establishes a wireless link between the host service and mobile device during which data messages can be transmitted. According to an embodiment, before an actual data message is sent to the mobile device, a small notification message is sent first to the mobile device to enable the mobile device to send a pull request to the host to fetch the actual message. In a preferred embodiment, if a data message is provided or received at the host service from an external source outside of an active service session, a corresponding notification message is sent while no session is active to nevertheless provide notification that a data message has been received at host service and is ready for retrieval. Upon activation of a session (e.g. user activation, user authentication, or session status change of the mobile device from inactive to active), a pull request is sent from the device to the host service to fetch the incoming data message. The data message may be an e-mail message.

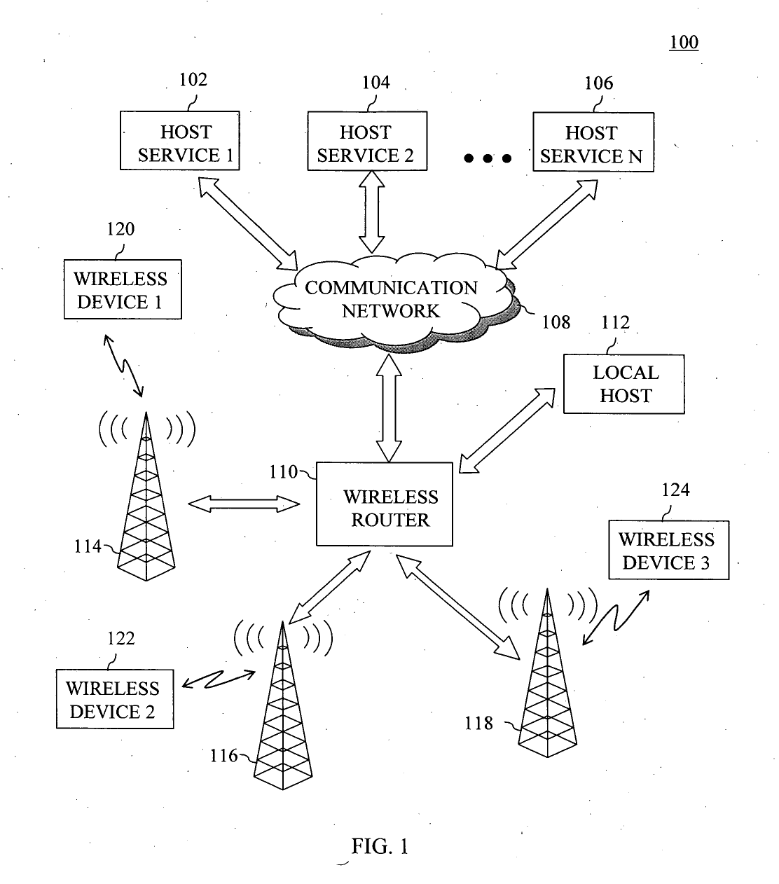

FIG. 1 is an exemplary wireless communication system 100 in which a wireless communication system in accordance with at least one of the preferred embodiments may be practiced. The exemplary wireless communication system 100 includes a plurality of host services (three shown, 102, 104, and 106), each of which may have a plurality of services such as, but not limited to, e-mail, calendar, Internet web browser, and other applications, available to their subscribers. The host services 102, 104, and 106 are connected to a communication network 108 such as Internet, which connects to a wireless router system 110 allowing communication between the host services 102, 104, and 106 and the wireless router 110. The wireless router system 110 may also be connected to a host service, such as a local service 112, without the communication network 108. The wireless router system 110 is connected to a plurality of wireless networks (three shown, 114, 116, and 118), each of which may support a plurality of mobile devices (one in each wireless network is shown, 120, 122, and 124). The wireless networks 114, 116, and 118 may be a cellular telephone network, a two-way paging network, a short range wireless network such as Bluetooth™ and IEEE 802.11 compliant network, and others alike, and the mobile devices 120, 122, and 124 are device compatible with the corresponding wireless network.

Mobile devices 120, 122 and 124 are two-way communication devices with advanced data communication capabilities having the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

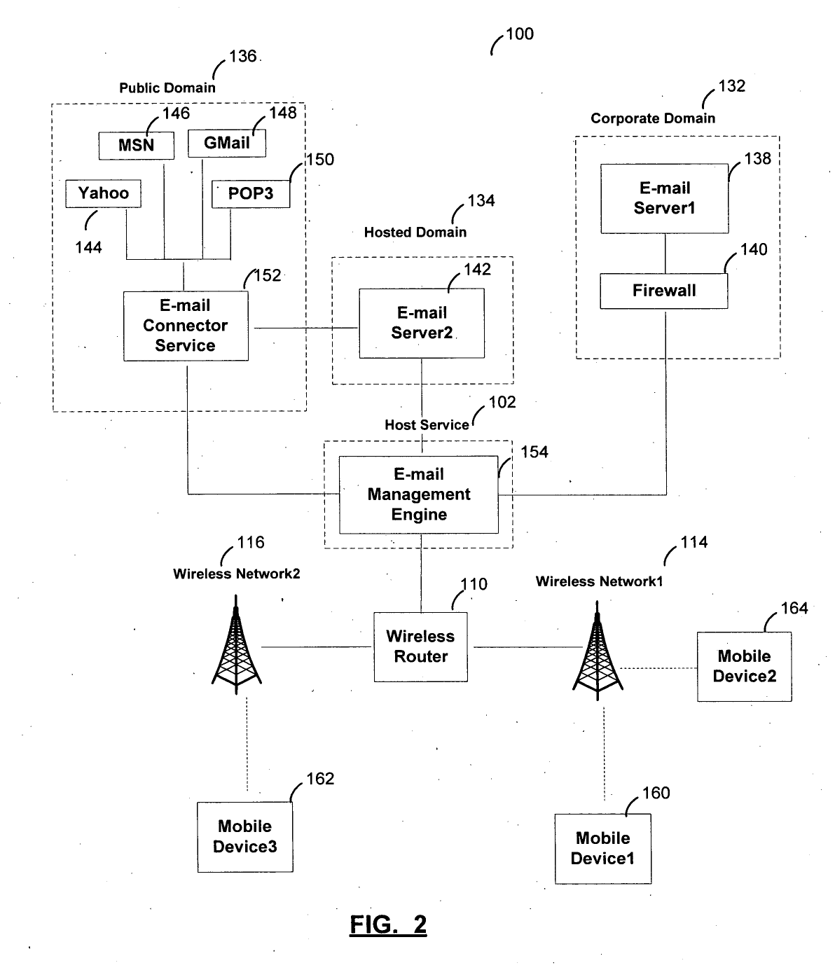

FIG. 2 is another exemplary illustration of a wireless communication system for message delivery from a plurality of e-mail servers to a plurality of mobile devices according to another preferred embodiment. In this example, wireless communication system 100 comprises a plurality of e-mail servers from different domains; a corporate domain 132, a hosted domain 134 and a public domain 136.

Corporate domain 132 is used to categorize the messaging system for any corporation, organization or private network. Corporate domain 132 includes enterprise E-mail Serverl 138 and a firewall 140. Examples of corporate e-mail servers may include Microsoft Exchange Server™, Lotus Notes™ and/or Novell Groupwise™.

Hosted domain 134 is used to categorize messaging systems hosted by wireless carriers, Internet Service Providers (ISPs) and/or Application Service Providers (ASPs). Within the hosted domain 134 is included E-mail Server2 142 that stores and manages e-mail messages. Some examples of hosted domains include AOL, Verizon, Earthlink or Cingular messaging services.

Public domain 136 is used to categorize messaging systems that provide free (or almost free) e-mail messaging services to the public. These e-mail systems may include Yahoo Mail™ 144, Microsoft MSN™ 146, Google GMail™ 148, and/or other POP3 related mail systems 1500. These mail systems all connect to an e-mail connector service 152 that consolidates different mail systems and protocols to communicate with a wireless host service 102. E-mail connector service 152 may be integrated into each respective mail system (144, 146, 148 or 150) or it may on a separate server.

In some instances, email servers from hosted domains 134 may redirect or “piggyback” off public domain messaging systems and use their infrastructure and back office to manage e-mail message delivery. For example, wireless carrier A may outsource the e-mail service management to Yahoo so their customers may receive Yahoo Mail™ branded as a service for carrier A.

Email servers from corporate domain 132, hosted domain 134 and public domain 136 all connect to a host service 102. In this specific embodiment, host service 102 is e-mail management engine 154. E-mail management engine 1544 is responsible for managing the retrieval, delivery and conversion of e-mail messages from a networked world to various wireless networks 114 and 116. E-mail management engine 154 may manage protocol conversion from Internet-based. TCP/IP, SMTP, IMAP, POP3 or MIME-based message and delivery protocols to more compact, efficient and/or secure wireless protocols such as CMIME, and UDP.

Once a message arrives at e-mail management engine 154, it is forwarded to wireless router 110 which redirects the message to the appropriate wireless networks 114 or 116, to deliver the message to the respective mobile devices 160, 162 or 164.

Each mobile device (160, 162 or 164 respectively) may be associated to one or more e-mail accounts from a corporate, hosted or public domain (132, 134, or 136 respectively). The management of account mapping is also controlled and stored by e-mail management engine 154. E-mail management engine 154 may also have alert, temporary message storage and message forwarding capabilities.

E-mail management engine 154 is the hub that connects to various email servers (138, 142, 144, 146, 148, 150), services (152) and one or more wireless routers (110) across the Internet using known TCP/IP-based protocols, leased lines (e.g., X.25 connections) and/or virtual private network (VPN) connections. Other secure Internet based connections may also exist. Wireless router 110 may also use the same or similar connection options to connect to multiple wireless networks 114 and 116 respectively.

In addition to e-mail messages, communication system 100 may also provide other services, such as telephony communications, paging, instant messages, Internet access, and other various data services to mobile devices 160, 162 and 164.

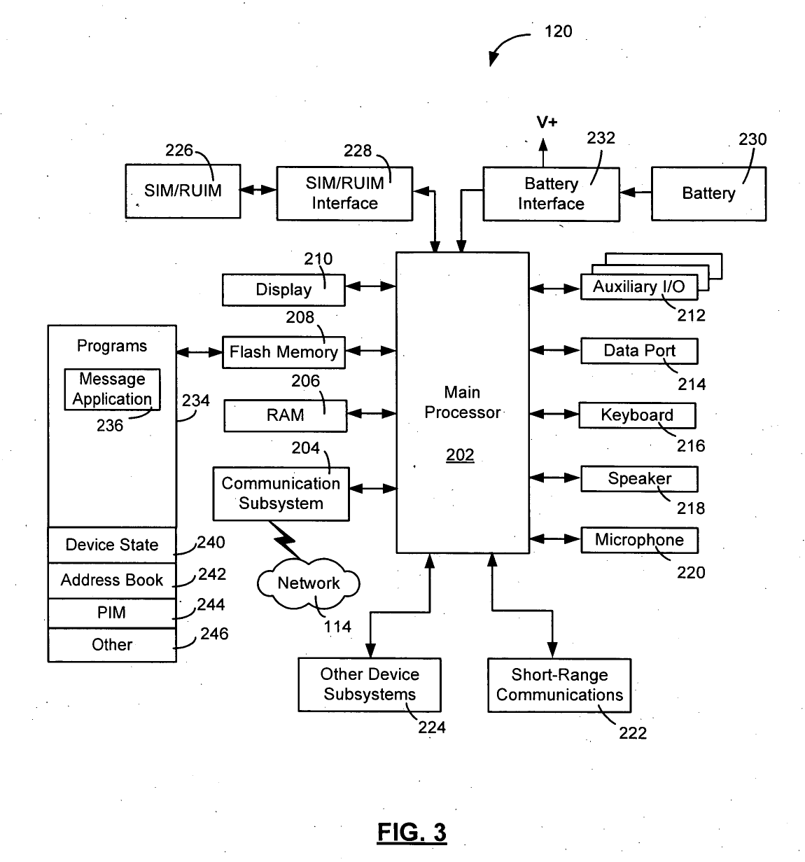

Referring to FIG. 3, shown therein is a block diagram of a mobile device 120 in one exemplary implementation. The mobile device 120 comprises a number of components, the controlling component being a main processor 202 that controls the overall operation of mobile device 120. Communication functions, including data and voice communications, are performed through a communication subsystem 204. The communication subsystem 204 receives messages from and sends messages to a wireless network 114. In this exemplary implementation of the mobile device 120, the communication subsystem 204 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is expected that they will have similarities to the network behaviour described herein, and it will also be understood by persons skilled in the art that the embodiments described herein are intended to use any other suitable standards that are developed in the future. The wireless link connecting the communication subsystem 204 with the wireless network 114 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 114 associated with mobile device 120 is a GSM/GPRS wireless network in one exemplary implementation, other wireless networks may also be associated with the mobile device 120 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (b 3G) networks like EDGE and UMTS. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 202 also interacts with additional subsystems such as a Random Access Memory (RAM) 206, a flash memory 208, a display 210, an auxiliary input/output (I/O) subsystem 212, a data port 214, a keyboard 216, a speaker 218, a microphone 220, short-range communications 222 and other device subsystems 224.

Some of the subsystems of the mobile device 120 perform communication-related functions, whereas other subsystems may provide “resident” or on-device functions. By way of example, the display 210 and the keyboard 216 may be used for both communication-related functions, such as entering a text message for transmission over the network 114, and device-resident functions such as a calculator or task list. Operating system software used by the main processor 202 is typically stored in a persistent store such as the flash memory 208, which may alternatively be a read-only memory (ROM) or similar storage element (not shown). Those skilled in the art will appreciate that the operating system, specific device applications, or parts thereof, may be temporarily loaded into a volatile store such as the RAM 206.

The mobile device 120 may send and receive communication signals over the wireless network 114 after required network registration or activation procedures have been completed. Network access is associated with a subscriber or user of the mobile device 120. To identify a subscriber, the mobile device 120 requires a SIM/RUIM card 226 (i.e. Subscriber Identity Module or a Removable User Identity Module) to be inserted into a SIM/RUIM interface 228 in order to communicate with a network. The SIM card or RUIM 226 is one type of a conventional “smart card” that can be used to identify a subscriber of the mobile device 120 and to personalize the mobile device 120, among other things. Without the SIM card 226, the mobile device 120 is not fully operational for communication with the wireless network 114. By inserting the SIM card/RUIM 226 into the SIM/RUIM interface 228, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 226 includes a processor and memory for storing information. Once the SIM card/RUIM 226 is inserted into the SIM/RUIM interface 228, it is coupled to the main processor 202. In order to identify the subscriber, the SIM card/RUIM 226 contains some user parameters such as an International Mobile Subscriber Identity (IMSI). An advantage of using the SIM card/RUIM 226 is that a subscriber is not necessarily bound by any single physical mobile device. The SIM card/RUIM 226 may store additional subscriber information for a mobile device as well, including date book (or calendar) information and recent call information. Alternatively, user identification information can also be programmed into the flash memory 208.

The mobile device 120 is a battery-powered device and includes a battery interface 232 for receiving one or more rechargeable batteries 130. In some embodiments, the battery 230 may be a smart battery with an embedded microprocessor. The battery interface 232 is coupled to a regulator (not shown), which assists the battery 230 in providing power V+ to the mobile device 120.

The main processor 202, in addition to its operating system functions, enables execution of software applications 234 on the mobile device 120. The subset of software applications 234 that control basic device operations, including data and voice communication applications, will normally be installed on the mobile device 120 during its manufacture.

The software applications 234 include a message application 236. The message application 236 can be any suitable software program that allows a user of the mobile device 120 to send and receive electronic messages. Various alternatives exist for the message application 236 as is well known to those skilled in the art. Messages that have been sent or received by the user are typically stored in the flash memory 208 of the mobile device 120 or some other suitable storage element in the mobile device 120. In an alternative embodiment, some of the sent and received messages may be stored remotely from the device 120 such as in a data store of an associated host system that the mobile device 120 communicates with.

Mobile device 120 further includes a device state module 240, an address book 242, a Personal Information Manager (PIM) 244, and other modules 246. The device state module 240 provides persistence, i.e. the device state module 240 ensures that important device data is stored in persistent memory, such as the flash memory 208, so that the data is not lost when the mobile device 120 is turned off or loses power. The address book 242 provides information for a list of contacts for the user. For a given contact in the address book, the information can include the name, phone number, work address and email address of the contact, among other information. The other modules 246 may include a configuration module (not shown) as well as other modules that can be used in conjunction with the SIM/RUIM interface 228.

The PIM 244 has functionality for organizing and managing data items of interest to a subscriber, such as, but not limited to, e-mail, calendar events, voice mails, appointments, and task items. A PIM application has the ability to send and receive data items via the wireless network 114. PIM data items may be seamlessly integrated, synchronized, and updated via the wireless network 114 with the mobile device subscriber's corresponding data items stored and/or associated with a host computer system. This functionality creates a mirrored host computer on the mobile device 120 with respect to such items. This can be particularly advantageous when the host computer system is the mobile device subscriber's office computer system.

Additional applications may also be loaded onto the mobile device 120 through at least one of the wireless network 114, the auxiliary I/O subsystem 212, the data port 214, the short-range communications subsystem 222, or any other suitable device subsystem 224. This flexibility in application installation increases the functionality of the mobile device 120 and may provide enhanced on-device functions, communication-related functions, or both. For example, secure communication applications may enable electronic commerce functions and other such financial transactions to be performed using the mobile device 120.

The data port 214 enables a subscriber to set preferences through an external device or software application and extends the capabilities of the mobile device 120 by providing for information or software downloads to the mobile device 120 other than through a wireless communication network. The alternate download path may, for example, be used to load an encryption key onto the mobile device 120 through a direct and thus reliable and trusted connection to provide secure device communication.

The data port 214 can be any suitable port that enables data communication between the mobile device 120 and another computing device. The data port can be a serial or a parallel port. In some instances, the data port 214 can be a USB port that includes data lines for data transfer and a supply line that can provide a charging current to charge the battery 230 of the mobile device 120.

The short-range communications subsystem 222 provides for communication between the mobile device 120 and different systems or devices, without the use of the wireless network 114. For example, the subsystem 222 may include an infrared device and associated circuits and components for short-range communication. Examples of short-range communication standards include standards developed by the Infrared Data Association (IrDA), Bluetooth, and the 802.11 family of standards developed by IEEE.

In use, a received signal or data message such as a text message, an e-mail message, or web page download will be processed by the communication subsystem 204 and input to the main processor 202. The main processor 202 will then process the received signal for output to the display 210 or alternatively to the auxiliary I/O subsystem 212. A subscriber may also compose data items, such as e-mail messages, for example, using the keyboard 216 in conjunction with the display 210 and possibly the auxiliary I/O subsystem 212. The auxiliary subsystem 212 may include devices such as: a touch screen, mouse, track ball, infrared fingerprint detector, or a roller wheel with dynamic button pressing capability. The keyboard 216 is preferably an alphanumeric keyboard and/or telephone-type keypad. However, other types of keyboards may also be used. A composed item may be transmitted over the wireless network 114 through the communication subsystem 204.

For voice communications, the overall operation of the mobile device 120 is substantially similar, except that the received signals are output to the speaker 218, and signals for transmission are generated by the microphone 220. Alternative voice or audio I/O subsystems, such as a voice message recording subsystem, can also be implemented on the mobile device 120. Although voice or audio signal output is accomplished primarily through the speaker 218, the display 210 can also be used to provide additional information such as the identity of a calling party, duration of a voice call, or other voice call related information.

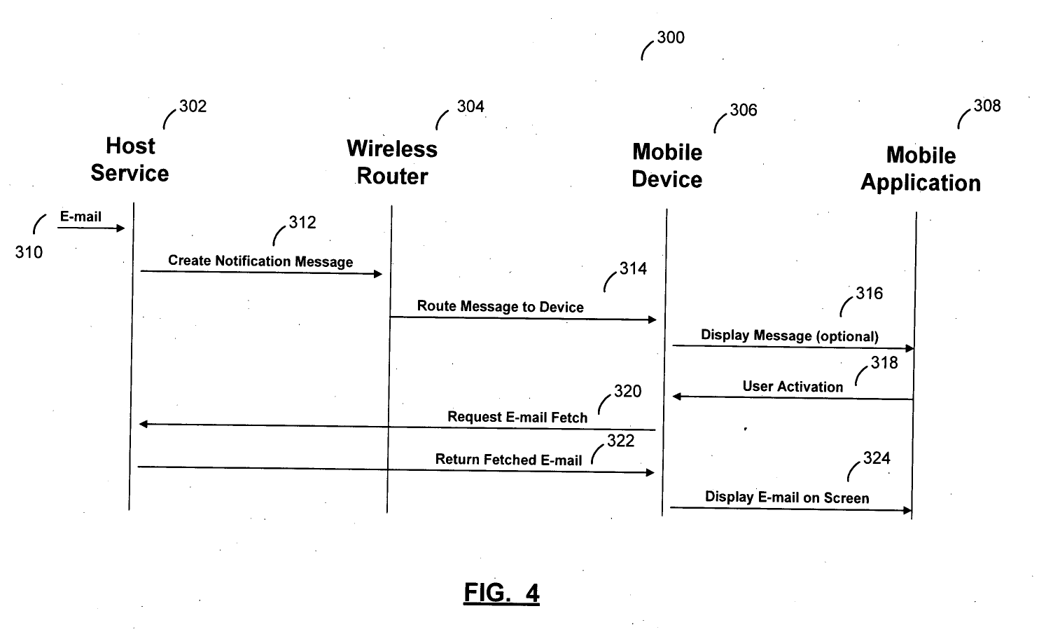

FIG. 4 is an exemplary sequence diagram illustrating the communication between different components of a wireless communication system 300. Communication system 300 comprises a host service 302, wireless router 304, and a mobile application 308 on mobile device 306. Host service 302 is synonymous with host service 102, 104 and 106 of FIG. 1 or 102 of FIG. 2, and handles data message delivery to and from mobile device 306. Host service 302 receives e-mail messages from its designated corporate email server, such as Microsoft Exchange™, Lotus Notes™, and/or Novell Groupwise™, and temporarily stores the content on a host service server (not shown). In addition to supporting corporate mail servers, host service 302 may, similarly to host service 102 of FIG. 2, handle public mail services such as Yahoo Mail™, Microsoft Hotmail™, Google GMail™, and the like. In addition to e-mail messages, host service 302 may also receive other forms of data messages, including SMS messages, MMS message, instant messages, phone messages, facsimile messages, calendar message, browser links, and application alerts.

In this particular example and for simplicity, host service 302 is shown as receiving an e-mail massage 310 but it is understood that host service 302 could also be shown receiving other types of data messages.

Once e-mail message 310 is received at host service 302, it is temporarily stored in memory. A notification message 312 is then created by host service 302 and sent to mobile device 306. Notification message 312 is a slim data packet that in one embodiment is a “microheader,” so named because it contains a subset of the fields in the header of the e-mail 310, but does not contain the payload (i.e., actual content of the email message). Such fields as reference ID, read status, alert level, date, and time may also be provided. The intent of the notification message is to enable the mobile (through message application 308) to request the source e-mail 310. Preferably, the notification message has only a few fields and a small file size. In one example, the notification message 312 is a relatively small packet that is often less than the size of a SMS message. To minimize file size, certain fields such as recipient (e.g., From, To, CC, BCC) and subject information can be omitted from the notification message 312. Notification message 312 may be as small as a reference field that enables the mobile to refer back to the original source e-mail 310.

The notification message 312 created by host service 302 also preferably notifies an end user of mobile device 306 of at least one new e-mail message received at host service 302. In one embodiment, a notification message is created for each e-mail message 310 that is received at host service 302. In another embodiment, notification message 312 could represent receipt of multiple e-mail messages and contain a list of message identifiers, each representing a different e-mail message received. In this embodiment, the notification message 312 is created upon receipt at the host of the first e-mail message in the group of messages. In yet another embodiment, notification message 312 could contain a field that indicates how many e-mail messages have been received at host service 302.

In one particular example, notification message 312 represents a single e-mail message received at how service 302 and is routed from host service 302 to mobile device 306 across a wireless router 304 during an active service session (“session”). An active session refers to the user being logged on to host service 302 to receive e-mail messages. During an active session, wireless router 304 redirects the notification message to its destination mobile device 306, at step 314, preferably without the end user viewing the contents of the notification message or being aware that mobile device 306 has received a notification message. If the session is inactive, the notification message is preferably sent to mobile application 308 of mobile device 306 for notification or alternatively can temporarily be stored in memory or cache at said host service 302 or wireless router 304 until the next session logon is detected.

Upon delivery to the mobile device 306, a mobile application 308, such as a messaging application, retrieves the notification message and, if the session is inactive, preferably displays it on the screen 316. In this case, mobile device 306 may display notification message 312 on mobile application 308 as an un-fetched message. However, it should be appreciated that the display of notification messages as an un-fetched version of e-mail messages in this embodiment is optional; mobile device 306 may also notify the end user in a variety of other ways, for example, by vibrating, emitting a audio sound, etc.

If a previous notification message has been received by mobile device 306 and upon the initiation of or during an active session (which for example may be triggered by user activation 318 of mobile device 306 and/or entry into mobile application 308 or other user activation event or device activation event (as further described below) all generally referred to as an activation event, a “fetch” or “pull” request, embodied as packet or message 320, is sent from mobile device 306 (using for example mobile application 308) to host service 302 to fetch the corresponding e-mail message 322. The fetched e-mail message is then displayed on the screen 324 by the desired mobile application 308. Upon delivery of the e-mail message 310, the e-mail that is temporarily stored in memory of the host service 302, is removed from memory. User activation 318 includes any activity generated by the user (details below).

During or upon initiation of an active session, mobile application 308 may request an email fetch 320 for each individual notification message 312 or request an email fetch for a batch of notification messages since the last fetch request. For example, if ten notification messages (i.e., representing ten un-fetched e-mail messages) have arrived since the last fetch request, mobile application 308 may send one batch fetch request 320 to request that all ten e-mails be retrieved from host service 302. Each e-mail message 310 will be returned as an individual fetched email 322 and will be updated and displayed accordingly by mobile application 308.

Activation events 318 are used to initiate an active session and may include such actions as a key press on keyboard 216, a thumb-wheel/scroll-wheel actuation, and/or an audible alert (e.g., a calendar event trigger or a phone call) on mobile device 306. A further activation event may include releasing mobile device 306 from the device holster or carrying case. For devices with touch-sensitive displays, sensing touch input on the display may be considered an activation event.

Radio activity such as detecting in and out of coverage conditions, powering the radio on/off, device power on/off events and regular “ping” status updates are also examples of activation event triggers 318. For example, if mobile device is out of coverage and returns back into coverage, the radio (i.e., part of communication subsystem 204) may sense a back in coverage state and send off a message to host service 302 that the device is back in coverage. Furthermore, for periods of inactivity, the device radio may send regular “ping” status updates to host service 302 to update communication system 300 with the device status and request for new notification messages 312 to be sent to the device 306. These “ping” status updates may be sent at certain user-configurable intervals (i.e., every 15 minutes).

A further example of an activation event is an Auto On/Off setting where the device is preconfigured to turn on/off at a predetermined time. For example, mobile device 306 may be set to turn on at 8:00 am weekdays (Monday to Friday). Mobile application 308 will sense this Auto On trigger, and may then establish an active session by logging into the service and fetching all outstanding e-mail messages at 8:00 am. Since the user is logged off most of the night, it conserves battery life for the device 306 and saves network capacity since the device 306 is not using the network while logged off.

In order to have an active session, mobile device 306 must be logged onto the session. As noted above, user authentication may be used to detect session logon. User authentication includes logging on to mobile device 306 by entering a login and/or password. If the password is authenticated (and deemed correct) a logon packet is sent to host service 302 to initiate an active session (i.e., session logon). In addition to device level authentication, authentication at the wireless network 114, host service 302, or wireless router 304 may also be considered.

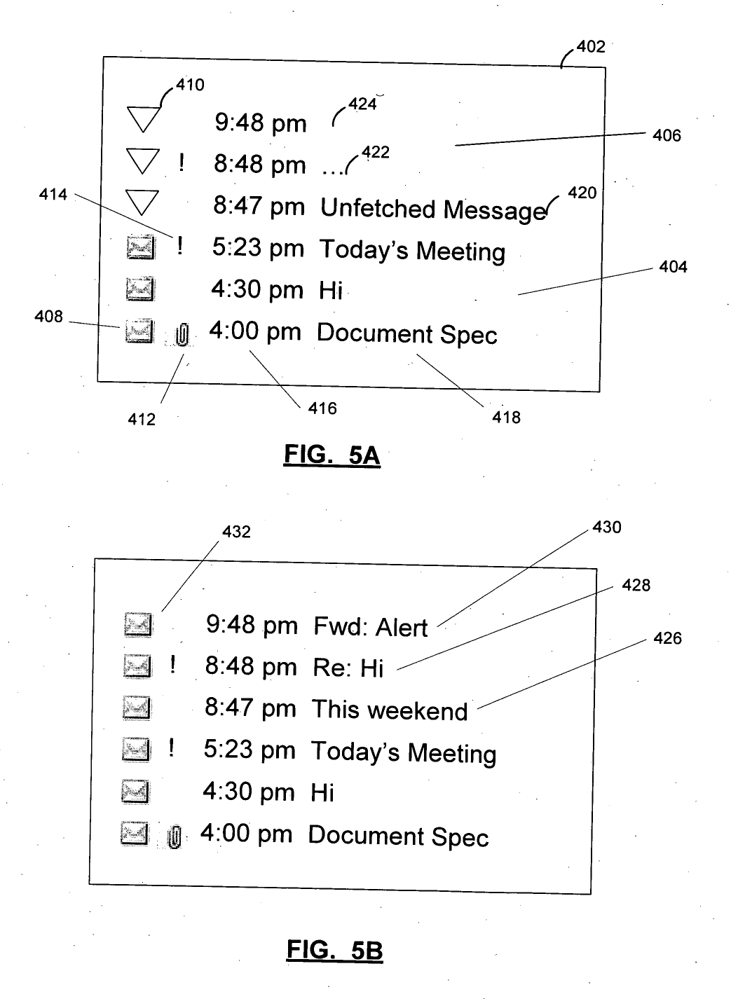

FIG. 5A is an exemplary block diagram illustrating the display of notification messages on a mobile device outside of an active session. In this example, mobile application 308 on mobile device 306 may display e-mail messages 404 and notification messages 406 in a message list 402. For each message, four fields are displayed: message type, a message status, a time stamp and a subject.

In this particular example, the message type includes such indicators as an envelope icon 408, indicating that the underlying message is an e-mail, and a notification message icon 410 indicating that the notification message also functions as an alert message to the end user. Other message types such, as an instant message, a SMS message, a MMS message, a calendar event, a browser link, or a phone call indicator, may also be displayed on messagelist 402 with its own unique icon.

Next to the message type field is a message status field that indicates the status of the message. An “!” entry 414 indicates that this is an urgent message. A “paperclip” entry 412 indicates that the message has attachments (or attaching documents) to the message. If the message status field is blank, it means that the message is a normal message. Other message status fields known in the art of e-mail message delivery may also be displayed.

The next field that is displayed is a time stamp 416 that indicates when the e-mail message is received on mobile device 306. Time stamp 416 may be listed in sequential order by most recent message, oldest message and/or another criteria selected by the user (i.e., categorized by message type).

The last field to be displayed in messagelist 402 is the subject field 418. Subject field 418 is the subject of e-mail message 310. Subject field 418 will be displayed in full if the message type is an e-mail (representing that the entire message has been fetched from the server). However, in certain embodiments, if the message displayed is a notification message 406, the subject field may not be available. As such, an “Unfetched Message” subject 420, “. . . ” subject 422 or a blank line subject 424 may be used. Other embodiments of a non-available subject field may also be used. Other fields such as a read status, a notification level, date and/or an indicator flag field may also be displayed.

Once a fetch message 320 is sent to the host service 302, the corresponding e-mail message 310 is fetched 322 and displayed on the screen 324 of the mobile application 308. At this time, the status of the message type displayed changes from a notification message indicator 410 to a regular e-mail message envelope 432, as illustrated in FIG 5B. Furthermore, the respective subject fields 426, 428 and 430 are populated to accurately reflect the subject of the e-mail message.

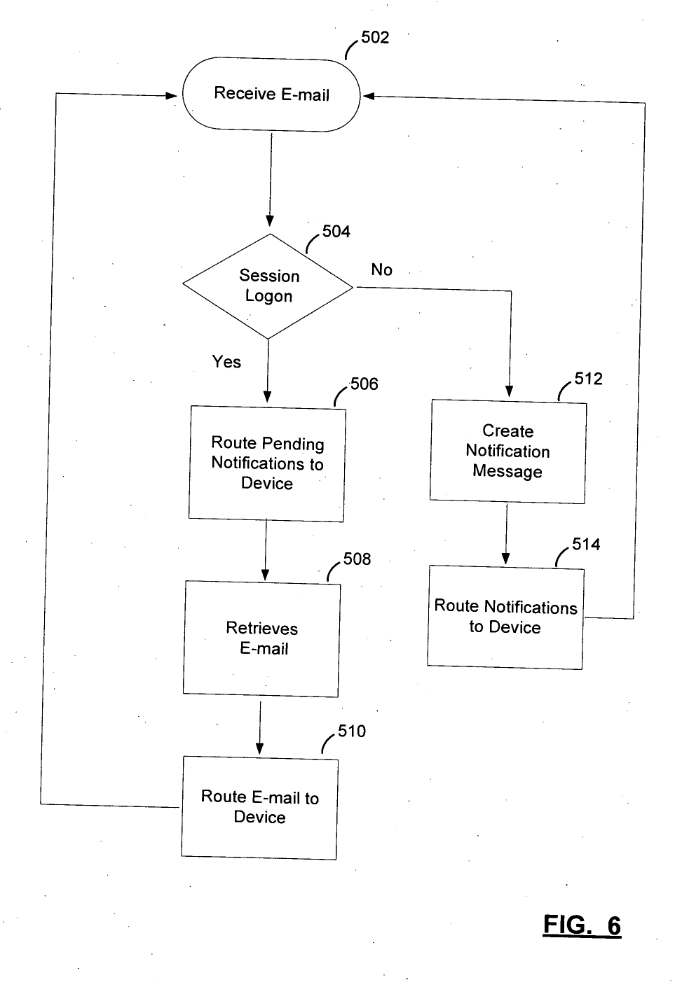

FIG. 6 is an exemplary flow diagram illustrating message delivery from a host service 302 based on session information. This process begins when a message communication system 300 receives an e-mail at host service 302, at step 502. Host service 302 then determines whether the mobile device 306 is logged onto an active service session, at step 504.

If the user is not logged into a session (e.g. inactive), host service 302 creates a notification message, at step 512 and routes the notification message to the mobile device 306, at step 514. In this particular example, for each incoming e-mail, host service 302 continues creating and sending these notification messages to mobile device 306, until a session logon (i.e. active session) is detected, at step 504.

If the user is logged on meaning that there is an active session, host service 302 checks to see if there are any outstanding notification messages that have not been sent to mobile device 306 when session was logged off, at step 506. If outstanding notification messages exist, host service 302 would then forward these messages to mobile device 306. Any one of many standard well known techniques may be used for logging the user into a session.

Upon detection of an active session, host service 302 retrieves the e-mail message, at step 506 and routes the message to the device, at step 508. The retrieved e-mail message at step 506 may be a duplicate of the original message, or it may be a forward of the original message.

In some embodiments, notification messages may not be necessary during an active session. Specifically, if host service 302 detects an active session and at least one previous notification message has been sent to the mobile device 306, subsequent e-mail messages can be directly sent from host service 302 to mobile device 306 without the need for additional notification messages. In this example, step 506 where pending notification messages are routed to mobile device 306 only occurs during the transition between inactive and active session states. Thereafter, during a active session, the process jumps from receiving an email at step 502, to detecting an active session at step 504, retrieving the e-mail at step 508 and finally, routing the e-mail to the mobile device at step 510.

An inactive session or session logged off state may be detected by one of many ways. One method is for the user to manually log off the device 306 or session. Another method of logging off a service is if the device has been idle for a period of time, usually exceeding a preset idle timeout interval. If the session has timed out, the user would need to authenticate (i.e., enter login and password), to re-establish login to the session.

A third method of logging off the system occurs when mobile device 306 has detected a reset. Upon restarting the device after a reset, the device may be logged off its session. By authenticating with the service (i.e., correct login password), the service would be re-established.

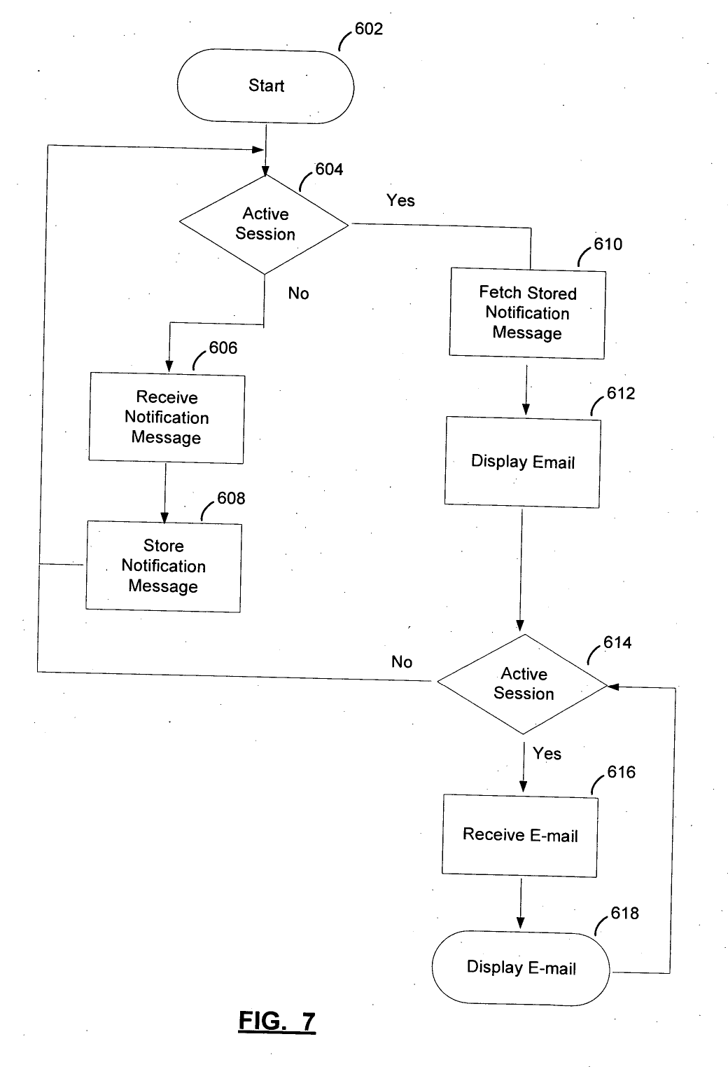

FIG. 7 is an exemplary flow diagram illustrating message receipt at the mobile device 306 based on session information. In this particular example, the process of retrieving email messages on mobile device 306 is based on the session state. Mobile application 308 or the operating system of mobile device 306 will fetch incoming e-mail messages based on the active or inactive session state. An active state occurs when the user is logged into a session with host service 302 and usually occurs when the device is in coverage. An inactive state occurs when user session is logged off or terminated and may include such scenarios as the device going out of coverage, device timeout, device shutdown or radio shutdown.

The aforementioned process of FIG. 7 starts at step 602 where mobile device 306 determines the session state. Mobile device 306 determines whether the service state is active, at step 604. If mobile device 306 is determined to be in an inactive state (i.e., logged off the system, out of coverage, etc.), the notification message created by host service 302 is received on the device, at step 606. It is then stored in memory, at step 608 and preferably displayed to provide notification to the mobile user that at least one e-mail message is ready for retrieval. These notification messages are either saved in flash memory 208, or RAM 206. The process then routes back to step 604 to reassess the active session state. When the device session state is determined to be inactive, a notification message is received and stored onto the device for every incoming e-mail received at host service 302.

If the mobile device 306 service state is determined to be active, at step 604, the device will then fetch any pending stored notification messages from host service 302, at step 610. These notification messages may optionally be displayed in mobile application 308, at step 612. The process then proceeds to step 614, whereupon an additional session state check occurs. If the state is deemed to be inactive again, at step 614, the process routes back to step 604 wherein the process continues receiving, storing and optionally displaying notification messages (steps 606 and 608) until an active state is redetected at step 604.

If the device session state is determined to be active, at step 614, mobile device 306 will receive all outstanding e-mail messages, at step 616. These messages will then be displayed on a mobile application 308 of mobile device 306, at step 618. Some examples of mobile applications include an e-mail application, a message list application, an instant message application or a unified messaging application. Once a message has been retrieved on mobile device 306, and if corresponding notification messages were previously displayed, the status for the notification messages is changed from “un-fetched message” to an actual e-mail message and the subject field may be replaced, as illustrated by element 432 of FIG. 5B. Once the message is displayed, at step 618, the process routes back to step 614 to reassess the active session state.

The determination of an active state, at steps 604 or 614, may occur by the trigger of one of many activation events. These events will inform host service 302 and/or mobile device 306 that the device would like to establish an active session and would like to initiate communication (i.e., send and receive messages).

In this aforementioned message communication system 300, e-mail messages are only sent to the user during an active session, for example, when the device is logged on or deemed available to receive e-mail messages. In one embodiment, when the device is logged off (i.e., session terminated), notification messages may be sent to the device, but not displayed to the end user. In another embodiment, notification messages sent to the device when the user is logged out may still be displayed to the end user. These notification messages may be as small as a reference ID, which is necessary to enable the mobile to retrieve the source e-mail message. Preferably, the notification messages include a few fields, such as the sender and subject fields, so the user can make a more informed decision to manually log onto an active session to retrieve the e-mail messages.

Sending notification messages conserves network capacity and allows more throughput on the wireless network so more devices (subscribers) can use the network. Furthermore, the session-based activation mechanism (i.e., only deliver e-mail messages when the device session is active) optimizes network efficiency by providing an on-demand delivery of messages.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of wireless messaging between a host service and a wireless mobile device comprising the steps of:
providing at least one data message at the host service;
creating a notification message at the host service, the notification message being indicative of the at least one data message provided;
delivering during an inactive service session the notification message to the mobile device;
receiving a pull request message in response to the notification message sent; and
in response to the pull request message received, delivering during an active service session the at least one data message provided to said mobile device.

2. The method of claim 1 wherein delivering during an inactive service session the notification message to the mobile device comprises displaying during the inactive service session the notification message on the mobile device.

3. The method of claim 2 wherein the notification message is displayed in a message list as an un-fetched version of the at least one data message.

4. The method of claim 1 wherein delivering the notification message to the mobile device comprises storing the notification message on the mobile device.

5. The method of claim 1 wherein the active service session is between the mobile device and the host service, and wherein prior to delivering the notification message during an inactive session, the method further comprising determining whether the session is active.

6. The method of claim 5 wherein the active session is subsequent to the inactive session.

7. The method of claim 1 wherein the at least data one message is one of an e-mail message, a SMS message, a MMS message, an instant message, a facsimile message, a phone messages, a calendar message, a browser link or an application notification.

8. The method of claim 1 wherein the notification message comprises at least one header field of the at least one data message.

9. The method of claim 1 wherein the notification message comprises at least one of a list comprising a message type field, a message status field, a read status field, an alert level field, a date field, a time field, a subject field and an indicator flag.

10. The method of claim 1 wherein the notification message comprises of at least one field that associates the notification message to the at least one data message.

11. The method of claim 1 wherein the notification message comprises at least one message identifier representative of the at least one data message or no message identifier.

12. The method of claim 1 further comprising during the active service session:
providing at least one other data message at the host service;
creating another notification message at the host service, the other notification message being indicative of the at least one other data message received; and
delivering the notification message to the mobile device.

13. The method of claim 1 wherein the host service is an e-mail management engine.

14. The method of claim 1 wherein providing at least one data message at the host service comprises:
providing a first data message received from a first e-mail account; and
providing a second data message received from a second e-mail account.

15. A method of wireless messaging comprising the steps of:
receiving at a mobile device a notification message during an inactive service session, the notification message being indicative of a data message; and
in response to the notification message received, requesting transmission of the data message during an active service session by sending from the mobile device a pull request.

16. The method of claim 15 wherein receiving at a mobile device a notification message during an inactive service session comprises displaying during the inactive service session the notification message on the mobile device.

17. The method of claim 16 wherein during the inactive service session, the notification message is displayed in a message list as an un-fetched version of the data message.

18. The method of claim 17 further comprising the step of receiving the data message during the active service session.

19. The method of claim 18 wherein during the active service session, the notification message is displayed as a fetched version of the data message after the data message has been received.

20. The method of claim 15 wherein prior to requesting transmission of the data message during the active service session, the method further comprising enabling the active service session at the mobile device in response to an activation event.

21. The method of claim 16 wherein the activation event is one of a user activation event or a device activation event.

22. The method of claim 20 wherein the activation event is one of a device key press, a scroll-wheel activation, a touch input, an audible notification, a radio power on, a radio power off, a device power on, a device power off, an in coverage alert, an out of coverage alert, a pre-configured alarm, a device auto-on event, a device auto-off event, a session log in, a session log out, an user authentication event, a status update event or a holster or case removal event.

23. A wireless mobile device adapted for wireless messaging comprising a message application adapted to receive a notification message during an inactive service session, the notification message being indicative of a data message, the message application being further adapted to request transmission of the data message during an active service session in response to the notification message received by sending a pull request.

24. The wireless mobile device of claim 23 wherein the message application is further adapted to receive the data message during the active service session in response to the pull request sent.

25. The wireless mobile device of claim 23 further comprising a display unit adapted to display the notification message during the inactive service session.

26. The wireless mobile device of claim 23 wherein the display unit is adapted during the inactive service session to display the notification message in a message list as an un-fetched version of the data message.

27. The wireless mobile device of claim 26 wherein the display unit is adapted during the active service session to display the notification message as a fetched version of the data message after the data message has been received.

28. The wireless mobile device of claim 23 further adapted to enter the active service session in response to an activation event.

29. The wireless mobile device of claim 28 wherein the activation event is one of a user activation event or a device activation event.

30. The wireless mobile device of claim 29 wherein the activation event is one of a device key press, a scroll-wheel activation, a touch input, an audible notification, a radio power on, a radio power off, a device power on, a device power off, an in coverage alert, an out of coverage alert, a pre-configured alarm, a device auto-on event, a device auto-off event, a session log in, a session log out, an user authentication event, a status update event or a holster or case removal event.
